(19) United States
(12) Patent Application Publication
(10) Pub. No.: US 2014/0332995 A1
(43) Pub. Date: Nov. 13, 2014

(54) SPECIMEN FOR DYNAMIC TESTING

(71) Applicants: Scott Powell Anderson, Greenville, SC (US); Steven M Cron, Greenville, SC (US); Michael Edward Dotson, Gunma (JP)

(72) Inventors: Scott Powell Anderson, Greenville, SC (US); Steven M Cron, Greenville, SC (US); Michael Edward Dotson, Gunma (JP)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 14/362,033

(22) PCT Filed: Nov. 27, 2012
(86) PCT No.: PCT/US12/66659

§ 371 Date: May 30, 2014

Related U.S. Application Data
(60) Provisional application No. 61/565,233, filed on Nov. 30, 2011.

(51) Int. Cl. B29C 39/26; G01N 3/22; B29C 67/24; B29C 39/36; B29C 39/10; B29C 39/38

(52) U.S. Cl. CPC B29C 39/26; B29C 39/10; B29C 39/38; B29C 67/246; B29C 39/36; G01N 3/22; B29L 2031/40
USPC 264/135; 425/542; 425/548; 264/259; 264/265

(57) ABSTRACT

Molds for preparing a viscoelastic material for dynamic analysis that include mold sections that when closed in alignment define such elements as a specimen cavity having an open end and dimensioned to provide a sample of the viscoelastic material of a predetermined size. Other elements may include a support member holder adjacent to the open end of the specimen cavity and a fill channel in fluid communication between the specimen cavity and a fill port. The fill port is adapted for receiving a reactive mixture of the viscoelastic material to fill the specimen cavity, wherein the support member holder is adapted for securing a support member having a surface that seals the open end of the specimen cavity.

### BACKGROUND OF THE INVENTION

1. Field of the Invention

This invention relates generally to materials testing and more specifically, to methods and apparatus for forming an elastomeric test specimen for dynamic testing.

2. Description of the Related Art

Dynamic testing of materials is an important tool useful to studying and characterizing materials, especially those materials that have exhibit viscoelastic behavior. Viscoelasticity is a well-known physical characteristic of some materials, such as rubber and certain other polymers, in that viscoelastic materials exhibit both viscous and elastic characteristics when they are stretched or otherwise deformed. Determining the properties of materials is important for understanding their usefulness in different design applications and many different techniques have been developed for determining such properties.

It is recognized by those in the materials testing field that proper preparation of the sample to be tested is important to ensure that the test method provides reliable information. In some test methods, including at least some of the dynamic test methods for materials, the material sample must be mounted in an apparatus where torsional and/or axial forces are imposed on it and measurements are made of its response. In some testing methods it is critical that the sample be properly mounted in a testing fixture that allows the materials to undergo torsional and/or axial forces and have their effects measured without interference from the mounting apparatus.

While proper mounting of test samples for some materials is well known, such as for many rubber compositions, there still remains a need to provide proper mounting and testing of samples for other materials.

### SUMMARY OF THE INVENTION

Particular embodiments of the present invention include molds for preparing a viscoelastic material for dynamic analysis. Such molds may include mold sections that when closed in alignment define such elements as a specimen cavity having an open end and dimensioned to provide a sample of the viscoelastic material of a predetermined size. Other elements may include a support member holder adjacent to the open end of the specimen cavity and a fill channel in fluid communication between the specimen cavity and a fill port.

The fill port adapted for receiving a reactive mixture of the viscoelastic material to fill the specimen cavity, wherein the support member holder is adapted for securing a support member having a surface that seals the open end of the specimen cavity.

Other embodiments include methods for using such molds that include preparing a bonding surface of a support member for bonding the viscoelastic material thereto and securing the support member in a mold. The prepared bonding surface of the support member borders an open end of a specimen cavity in the mold wherein the specimen cavity is dimensioned to provide a sample of the viscoelastic material of a predetermined size.

Such methods may further include filling the specimen cavity with a reactive mixture of the viscoelastic material and curing the reactive mixture to form the viscoelastic material. After curing, the method may further include removing the support member from the mold with the viscoelastic material bonded thereto.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIGS. 1A-1E are perspective drawings of exemplary sample specimens of a viscoelastic material having varying configurations prepared for dynamic testing.

FIGS. 2A-2B are perspective views of mold plates suitable for molding a viscoelastic material as a sample for dynamic testing.

FIG. 2C is a cross-sectional view of a pin that can be secured in the mold shown in FIGS. 2A-2B.

### DETAILED DESCRIPTION OF PARTICULAR EMBODIMENTS

Reference will now be made in detail to embodiments of the invention, one or more examples of which are illustrated in the drawings. Each example is provided by way of explanation of the invention. For example, features illustrated or described as part of one embodiment can be used with another embodiment to yield still a third embodiment. It is intended that the present invention include these and other modifications and variations.

Particular embodiments of the present invention include methods for preparing a viscoelastic material for dynamic analysis as well as molds that may be utilized in such methods. As used herein, viscoelastic materials are those materials as known in the art that exhibit both viscous and elastic behavior after being deformed. As such, these materials return essentially to their original shape after being deformed but do so with a loss of energy. Many viscoelastic materials are polymers such as rubber and polyurethanes.

Dynamic testing of viscoelastic materials is important to determine their physical properties. Generally dynamic testing provides measurements of a material's response to periodically varying strains or stresses, such as, for example, oscillatory shear deformations. One example of a method for determining dynamic properties of viscoelastic materials is fully explained in the ASTM D5992-96 standard guide for testing elastomeric materials, which is hereby fully incorporated by reference. This test method describes testing of materials over temperature ranges of between −70° C. and 200° C. and frequency ranges of between 0.01 Hz and 100 Hz. Viscoelastic materials that are typically tested with this method have dynamic moduli of between 100 kPa and 100,000 kPa. Dynamic testing of viscoelastic materials can provide such physical properties as, for example, their dynamic modulus, glass transition temperature, shear modulus and hysteretic properties.

While the actual test procedures that are used to determine the dynamic properties of viscoelastic materials are not a part of the present invention, it should be recognized that such testing subjects a sample of the material to a stress or a strain and the resulting effect on the material is measured. Such testing may be done at constant temperature or at varying temperature so that the effect of temperature may be determined. The stress or the strain may be constant or it may vary over a range. The testing procedures may, for example, include translational or rotational methods so that the sample may be subjected to a force and the displacement measured, subjected to a torque and the angular deflection measured, subjected to a displacement and the force measured or subjected to an angular deflection and the torque measured.

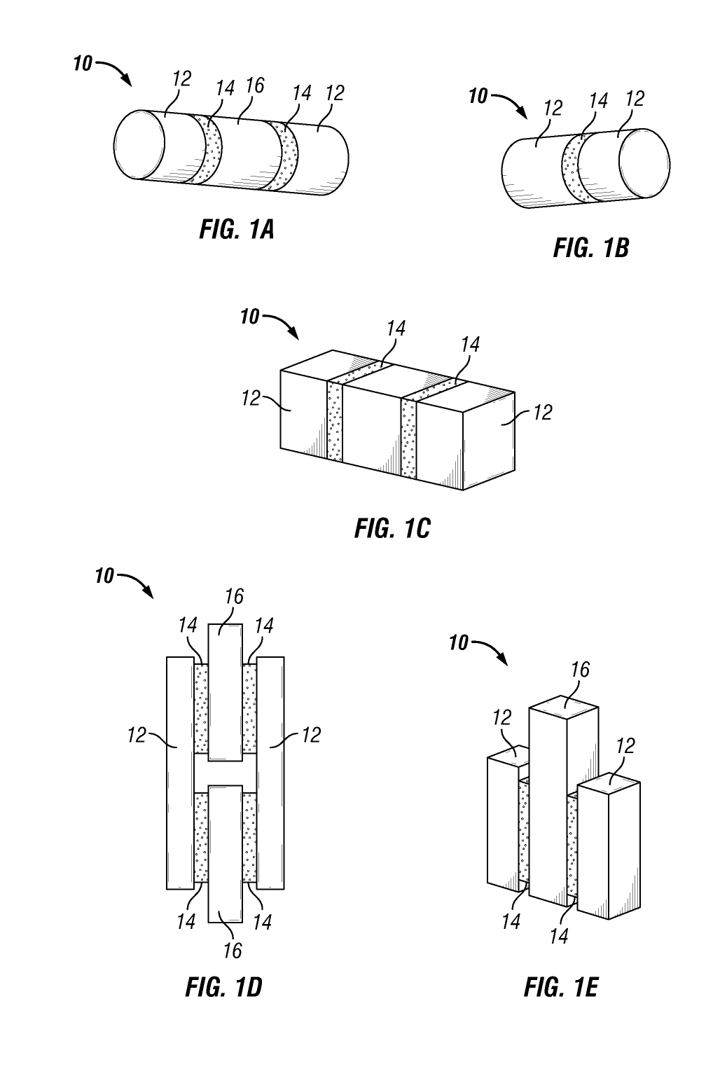

To conduct such testing, the viscoelastic material is gripped by a structure that imparts the stress and/or strain on the viscoelastic material during the testing. FIGS. 1A-1E are perspective drawings of exemplary sample specimens of a viscoelastic material having varying configurations prepared for dynamic testing. These figures include several different sample specimens 10 suitable for undergoing dynamic testing. It should be noted that the examples shown are not meant to limit the invention in any way but merely provide examples of configurations of samples for dynamic testing.

In these figures, a sample of viscoelastic material 14 is sandwiched between support members 12, 16. While the shapes in these examples are shown to be squares, rectangles and circles, the samples 14 may be of any shape suitable for the testing to be conducted and the supporting members 12, 16 may be of the same shape as the viscoelastic material 14 or a different shape as may be suitable for the testing method.

FIG. 1B illustrates a single specimen 14 arrangement while FIGS. 1A, 1C and 1E illustrate a double specimen 14 arrangement. FIG. 1D illustrates a quadruple specimen 14 arrangement. These examples further demonstrate the wide range of suitable testing configurations that may be useful for dynamic testing.

Looking more closely at FIG. 1B, the sample of viscoelastic material 14 is bonded to the support members, the support members being the two pins 12 that sandwich it. During the dynamic testing, one of the pins 12 may be held stationary while the other pin is moved to assert either a translational or rotational force on the sample 14. In the double sample configurations of FIGS. 1A, 1C and 1E two samples of the viscoelastic material 14 are bonded between support members that are three pins (or plates), two outside pins (or plates) 12 and a center pin (or plate) 16. During dynamic testing, the center pin (or plate) 16 may be held stationary while the two outer pins (or plates) 12 are moved to assert either a translational or rotational force on the samples 14. Alternatively, the outer pins (or plates) 12 may be held stationary while the center pin (or plate) 16 is moved to assert either a translational or rotational force on the samples 14.

In the quadruple configuration of FIG. 1D, there are four samples 14 of the viscoelastic material bonded to two outer plates 12 and two center plates 16. During dynamic testing, the center plates 16 may be held stationary while the outer plates 12 are moved to assert either a translational or rotational force on the samples 14 or alternatively, the center plates 16 may move while the outer plates 12 are held stationary, at least in the vertical plane.

These figures illustrate the varied configurations by which the sample of viscoelastic material may be subjected to dynamic testing to determine, for example, its shear modulus. In each case, the sample of viscoelastic material is bonded to a surface of the support member and the support member is then moved to apply either rotational or translational forces on the sample. Particular embodiments of the present invention provide molds and methods for bonding the viscoelastic material to the surface of the support member as, for example, the end of a pin or the side of a plate used in the dynamic testing procedures.

For some materials, such as rubber, it is well known that a sample of cured rubber can be bonded with an adhesive to the bonding surfaces of the support members, such as the pins shown in FIG. 1A. Only a small amount of the adhesive is typically applied to the pins for bonding the cured rubber sample to the bonding surfaces with adequate strength to maintain the bonds during the dynamic testing procedure.

Such is not the case, however, for some other viscoelastic materials. Because of the forces that are asserted and the measurements that are taken on the samples being tested, the samples should be bonded well enough to the support member to prevent the bonds from even partially breaking or otherwise loosening during the dynamic testing process; otherwise the test results will be flawed. Likewise, the adhesive layer must be thin enough so as not to significantly impart its own physical characteristics to the dynamic testing results. Particular embodiments of the present invention therefore provide molds and methods for their use in which samples of viscoelastic materials are prepared for dynamic testing by being cured and bonded to the bonding surfaces of the support members in the mold.

Such molds include mold sections that when aligned and closed define certain elements. The mold sections may include, for example, two or more plates that may be aligned to form the mold and are opened and closed at the mold's parting plane. Typically the surfaces of the parting plane are machined flat to ensure a good alignment and close (tight) fit so that the material being molded stays within their mold elements and doesn't leak into regions between the plates at the parting plane. Such molds may have, for example, alignment pins that extend through the mold sections, typically threaded, that align the mold sections and hold the mold shut. Alternatively the mold sections may be held closed, for example, by clamps or bands.

Particular embodiments of the molds disclosed herein are useful for molding viscoelastic material for dynamic testing to provide, for example, the exemplary sample specimens shown in FIGS. 1A-1E. Such molds receive a reactive mixture of the viscoelastic material to be dynamically tested so that the material is cured within the molds. The reactive mixture is a fluid that can flow through the fill channels formed by the mold and into specimen cavities provided for molding the sample. The reactive mixture is then cured in the mold and bonded to the bonding surfaces of the support members that are also placed in the mold before the mold is closed. Thus, when the mold is opened, the cured sample of viscoelastic material is bonded to the bonding surface(s) of the support member(s).

It should be noted that the support members may be made of any suitable material and are often made, for example, from stainless steel or aluminum. Any material that can adequately support the viscoelastic material during dynamic testing, withstand the forces applied during the testing and provide a suitable bonding surface for the viscoelastic material are typically acceptable. It is sometimes also preferred that the support members be constructed of a material having a high stiffness so that they do not themselves deform during the testing and influence the test results of the viscoelastic material.

The dimensions of the support members may be set by the dynamic testing procedure being used, such as ASTM Test Method D5992, and/or by the manufacturer of the machine being used to perform the testing. Without limiting the invention, suitable dimensions of exemplary support members include pins that are between 10 mm and 30 mm long having a diameter of between 5 mm and 25 mm.

The specimen cavity formed by the mold when it is closed is dimensioned to provide a sample of the viscoelastic material that is adequate for dynamic testing. The methods used for dynamic testing typically provide a range of suitable test sample dimensions and the mold may be formed with a specimen cavity that provides the test sample with the proper predetermined dimensions as required by the dynamic testing procedure being used. Without limiting the invention, suitable dimensions of the test samples include lengths of between 1.5 mm and 6 mm and diameters of between 5 mm and 25 mm, such samples having pins as support members.

The specimen cavity formed by the mold sections when closed has at least one open end that is sealed by a bonding surface of the support member held in the mold. The bonding surface of the support member therefore provides the wall that seals the specimen cavity for molding the material sample and, as the viscoelastic material is cured in the mold, provides the bonding surface to which the viscoelastic material bonds. Of course many embodiments include molds having more than one specimen cavity, as in the case of the molds useful for forming the specimens shown in FIGS. 1A-1E Likewise such molds would provide specimen cavities having more than one open end with each open end sealed by a bonding surface of a support member.

It should be recognized by those having ordinary skill in the art that if the bonding surface seals the specimen cavity opening, the bonding surface should be dimensioned and placed in the mold with tight tolerances so that the opening is sealed when the bonding surface of the support member is properly placed in the mold. If the bonding surface of the support member is too large or too small compared to the size of the opening, or if a gap between the specimen cavity opening and the bonding surface is too large, the bonding surface will not properly seal the specimen cavity opening and the viscoelastic material will flow out around the bonding surface of the support member instead of filling the sealed specimen cavity with the viscoelastic material.

In general it may be recognized that the mold provides a specimen cavity having an open end (or ends) into which the reactive mixture of viscoelastic material flows to form the test sample. The open end(s) of the specimen cavity are sealed with the bonding surface(s) of the support member(s) placed in the mold so that the viscoelastic material can bond to these exposed surfaces as the material cures in the specimen cavity. In other words, it is the support member bonding surfaces that seal the specimen cavity opening(s) to contain the viscoelastic material until it is cured in the mold and to which the viscoelastic material bonds as it cures to create the test sample specimen.

In addition to the specimen cavity for molding the viscoelastic material into the properly dimensioned specimen, the closed mold forms other elements that include the support member holder and the fill channel.

The support member holder is formed in the mold to provide space in the mold for the support member so that the mold can be closed around it and to position it in the mold so that its bonding surface can seal the specimen cavity opening. More specifically, as noted above, the mold is closed with the support member(s) inside the mold so that when the sample material is poured into the mold to form the test specimen, the bonding surfaces of the support members seal the openings of the cavities so that the viscoelastic material can bond to their surfaces. The support member holder may be, for example, a groove formed in the mold into which the support member can be placed so that the mold can be closed around the support member.

In particular embodiments it is preferred that the support members be secured within the support member holders so that they do not shift while the mold is being filled with the reactive mixture of viscoelastic material and so that they are properly positioned to ensure that their bonding surface seals the opening in the specimen cavity to contain the viscoelastic material therein.

To properly secure the support member in the support member holder, particular embodiments include a ridge in the support member holder that is adapted to fit a notch in the support member. The support member may then be placed in the support member holder secured by the ridge that fits into its notch. This both secures the support member and exactly positions the support member in the mold. The ridge may be formed, for example, by machining or otherwise forming the ridge in the support member holder. A removable bar may also be secured by the mold section within the support members to act as the ridge. Magnetic forces may also be used to secure the support members within the support member holders if the support members are formed of a material that is subject to magnetic forces. Pins or ridges extending from the support members (or support member holders) may also fit into holes or grooves provided in the support member holders (or support members) to position and secure the support members.

As noted above, the fit of the bonding surface to the opening of the specimen cavity should be close enough in particular embodiments of the present invention to ensure that the bonding surfaces seal the openings in the cavities. As such, precise placement of the support members in relation to the specimen cavity openings ensures that the openings are properly sealed. Tolerances in the range of about 0.05 mm are often adequate to ensure proper sealing of the openings.

An additional element formed by the mold sections when they are closed is the fill channel that is in fluid communication between a fill port and the specimen cavities. The reactive mixture of the viscoelastic material may be poured or otherwise introduced into the fill port so that it flows through the fill channel to fill the specimen cavities. There may of course be a flow channel that flows to only one specimen cavity so that the number of flow channels is equal to the number of cavities to be filled. Alternatively a flow channel may branch and provide material to more than one specimen cavity. In particular embodiments, a flow channel may include a series of gates as known in the art, wherein a gate provides fluid communication between the flow channel and one specimen cavity.

It may be recognized that any combination of flow channels with or without gates is within the contemplation of particular embodiments of the present invention so long as the reactive mixture of viscoelastic material can be introduced into the mold and flow to a specimen cavity where the material cures and bonds to a bonding surface of a support member.

In particular embodiments it is contemplated that the reactive mixture will flow through the channels to the specimen cavities by gravity. In other embodiments, the reactive mixture may be pumped or otherwise injected into the mold through the fill port such as, for example, in an injection molding process, such as in reactive injection molding process. Particular embodiments may further include a reservoir formed in the mold at the opposite end of the fill channel from the fill port, the reservoir adapted to collect excess material and ensure that the cavities are full.

In particular embodiments it may be preferred to fill the mold from a fill port that is lower in the mold so that the mold fills from the bottom up, thereby allowing air to escape from an opening in the top of the mold. In other embodiments, the mold may be filled from the top without problems of air entrapment, especially if the material is not highly viscous and the material is introduced into the flow channels at a rate slow enough for the air to escape.

The curing of the viscoelastic material in the molds may take place at an elevated and/or lower temperature than ambient so in particular embodiments, channels may be formed in one or more of the mold sections through which a thermal fluid may be circulated to heat and/or cool the mold. Thermal fluids may include, for example, water, oil, steam and so forth. Alternatively, the mold may be placed in an oven or refrigerator to heat or cool the mold so that the reactive mixture can properly cure. Electrical heating coils may also be embedded in the mold section and/or wrapped around the mold body.

The molds disclosed herein can be used with any viscoelastic material that can be poured or otherwise injected into the mold as a fluid and then cured to form the viscoelastic material for dynamic testing. Such materials may include, for example, polyurethanes, polyuria, polyamides, epoxy and silicones. In particular embodiments, a reactive mixture of the viscoelastic material is introduced into the mold where the reactive mixture is cured to form the viscoelastic sample to be tested.

Polyurethane is a specialty polymer that is used in a wide variety of commercial applications including, for example, elastomers. The chemistry of polyurethane makes use of the reaction of an isocyanate (—N═C═O) with an active hydrogen compound (R—OH) or (R—NH₂) to produce the class of polymers known as polyurethane, which includes the group of polyurethane-urea polymers that are produced by the reaction of R—NH₂ with the isocyanate. The reactive ingredients are mixed together and placed in a mold that is then heated so that the reactive mixture can react and cure to form the polyurethane. The reactive mixture may also include a catalyst as well as, for example, pigments, foaming agents, fillers and so forth as known in the art.

More specifically, polyurethane may be formed by reacting components that include (1) a polyol, (2) an aromatic, alicyclic or aliphatic polyisocyanate or combinations thereof and (3) a chain extender or curative.

The polyol reaction component contains at least two isocyanate-reacting groups that are attached to a single molecule. The molecule may be, for example, a polyester, a polyether, a polycaprolactone, a polypropylene glycol or combinations thereof and may be a hydroxyl-terminated polyol, an amino-terminated polyol or combinations thereof. Suitable polyols are well known in the polyurethane art and include polyether polyols, amine-terminated polyols, polyester polyols, polyester ether polyols, castor oil polyols, polycyclic polyols and polycarbonate polyols.

The aromatic, alicyclic and/or aliphatic polyisocyanate reaction component may be characterized as a polyisocyanate having two or more aliphatically, alicyclically or aromatically bound isocyanate groups. Examples may include 1,6-diisocyanatohexane (HDI), 1-isocyanato-5-isocyanatomethyl-3,3,5-trimethylcyclo-hexane (IPDI), 2,4-toluene diisocyanate (TDI), and 4,4′-diphenyl-methane diisocyanate (MDI)

As is known in the polyurethane art, the polyol and the polyisocyanate reaction components may be mixed first to form a prepolymer. The prepolymer may then be mixed with the chain extender (curative) to produce the polyurethane.

The chain extender is often characterized as being a short-chained dialcohol, a short-chained diamine or combinations thereof. Embodiments of the polyurethane may include a di-, tri-, and/or tetra-alcohol and/or amine but typically a diol or a diamine is selected as the second chain extender.

Examples of suitable short-chained chain extenders include, for example, 1,2, ethanediol, 1,2 propanediol, 1,2 butanediol, 1,2 butanediol, ethylene diamine, 1,2 propane diamine, propylene diamine, propylenediol, 4,4′-methylene bis-(3-chloro-2,6-diethylaniline) (MCDEA), 4,4′-methylene bis(2-chloroaniline) (MOCA), diethylthiotoluenediamine (DETDA) and dimethylthiotoluenediamine (DMTDA).

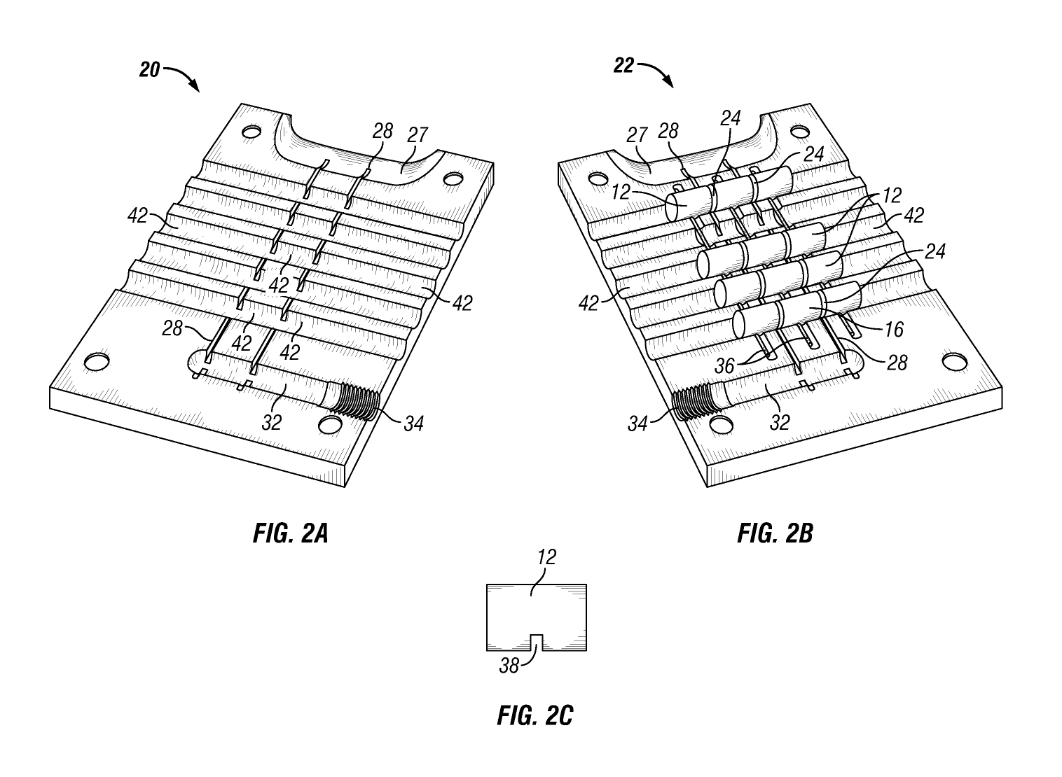

FIGS. 2A-2B are perspective views of mold plates suitable for molding a viscoelastic material as a sample for dynamic testing. The mold plates 20, 22 when closed in alignment form a specimen cavity 24 into which the viscoelastic material can flow and then cure into a suitable sample for dynamic testing. Threaded holes are provided through which bolts (not shown) may be inserted for aligning the mold sections and holding the mold closed.

The specimen cavity 24 is open on either end but is sealed by the bonding surfaces of the pins 12, 16 that are adjacent to the open ends. The viscoelastic material can then be contained within the walls of the mold plates 20, 22 and the pins 12, 16 where it can be cured and bonded to the ends of the pins.

The pins 12, 16 are held within the mold plates 20, 22 in grooves 42 that are cut into the mold plates 20, 22. To prevent the pins from moving, a ridge 36 in the grooves 42 is provided that fits into a corresponding slot in the pins 12, 16.

FIG. 2C is a cross-sectional view of a pin that can be secured in the mold shown in FIGS. 2A-2B. As can be seen in this figure, a pin 12 is provided with a slot 38 that can receive the ridge 36 provided in the grooves 42 of the mold plate 22.

A fill channel 28 is cut into the mold plates 20, 22 that is in fluid communication with the cavities 24 and the fill port 27. The reactive mixture of the viscoelastic material can be introduced into the fill port 27 and flow through the fill channel 28 to fill the specimen cavities 24 with the sample material. Excess sample material can flow into the reservoir 32. A threaded plug (not shown) can be inserted into the threaded reservoir opening 34 to prevent the material from flowing out.

Alternatively, the reactive viscoelastic material can be fed through a connection to the threaded reservoir opening 34 and filled from the bottom up so that excess material exits the fill port 27. This means of filling may be preferred if air entrapment is a problem. When the liquid material flows into the bottom of the mold, the air can easily escape from the top of the mold. Of course in this method, the material must be pumped or gravity fed into the threaded reservoir opening 34.

Particular embodiments of the present invention include methods for preparing a viscoelastic material for dynamic analysis using a mold as disclosed herein. Such methods may typically include preparing the bonding surface of the support member for bonding the viscoelastic material thereto and may also include preparing the mold for molding the thermoplastic material. The molds may be typically cleaned to remove any dirt, grime or remnants from previous molding operations. The mold may also be treated with a mold release agent that helps release the molded material from the mold. Common mold release agents include those based on silicone, wax, oils and so forth. Selection of a mold release agent is dependent upon the viscoelastic material being molded.

The support members may be treated to prepare the bonding surface so that the viscoelastic material better bonds to them. The bonding surfaces may be roughened to promote better bonding of the viscoelastic material to the bonding surfaces. The surfaces may be roughened through known techniques such as sand blasting, grinding, brushing and so forth. The bonding surfaces may also be cleaned with a solvent, detergent or other cleaning agent to remove oils and other contaminants that may interfere with the bonding of the viscoelastic material to the bonding surface.

In some embodiments, the method may include applying an adhesive to the bonding surface to promote the bonding of the viscoelastic material to the bonding surface of the support member. Selection of a suitable adhesive would be dependent upon the type of viscoelastic material. For example, when preparing a sample of polyurethane to the support member during the molding process, an adhesive such as Cytec CONAP 1146-C may be suitable. This adhesive promotes the bonding of a liquid reactive mixture of a polyurethane material to a surface while it is curing. The adhesives useful for particular embodiments of the present invention are those that adhere well to the bonding surface of the support structure and react or otherwise interact with the curing viscoelastic material in the mold, an example of which is CONAP 1146-C.

After any mold preparations are performed and the support member bonding surfaces are prepared, if any such preparations are made, the support members may be placed in the mold so that the bonding surfaces will be contacted by the reactive mixture of the viscoelastic material introduced into the mold. In particular embodiments of the invention, the support member borders an open end of a specimen cavity in the mold where the specimen cavity is dimensioned to provide a sample of the viscoelastic material of a predetermined size.

In particular embodiments, the support members are secured in the support member holders in the mold, such securing being achieved, for example, with magnetic forces and/or with slots and/or ridges in the support members fitting into ridges and/or slots in the support member holders. Such securing assures that the support members are well secured during the molding process and further provides aligning of the support members with the open end of the specimen cavity, thereby ensuring that the open end of the specimen cavity is properly sealed by the bonding surface of the support member to complete the closure of the specimen cavity for containing and molding the viscoelastic sample.

Such methods may further include filling the specimen cavity with a reactive mixture of the viscoelastic material. The specimen cavity may be filled by feeding the mixture into the mold by gravity and/or my injecting the material into the specimen cavity, for example with a pump and/or extruder.

Curing the viscoelastic material may take place at a temperature that requires heating the mold and/or cooling the mold. Such methods may include, for example, circulating a thermal fluid through channels formed in the mold body. Examples of thermal fluids may include water, oil and/or steam. Alternatively the method may include heating the mold in an oven and/or cooling the mold in a refrigerator.

After the material is properly cured in the mold, the method may include opening the mold and removing the support member from the mold with the viscoelastic material bonded to the bonding surfaces of the support member.

The invention is further illustrated by the following examples, which are to be regarded only as illustrations and not delimitative of the invention in any way.

### EXAMPLE 1

A double shear specimen similar to that shown in FIG. 1A was prepared using polyurethane as the viscoelastic material. First the bonding surfaces of the pins were prepared by sandblasting the surfaces to provide a surface roughness. The pins were then rinsed in acetone and allowed to air dry. An adhesive was sprayed on the bonding surfaces to a thickness of between 12 μm and 25 μm and then allowed to dry. The adhesive was a mixture of Cytec Conap 1146-C adhesive and Cytec Conap S-1 solvent mixed at a 1:4 ratio.

The treated pins were then placed in a mold similar to the one shown in FIGS. 2A-2B. The mold had been cleaned and prepared with a mold release, STONER M-804, which is silicone based. The mold was closed and heated in an oven for two hours at 100° C. An off-the-shelf polyurethane prepolymer (Chemtura VIBRATHANE B836) heated to about 70° C. was then mixed with a mixture of a short chained diol curative and catalyst heated to about 45° C. The reactive mixture was poured into the fill port at the top of the mold. Within three minutes the mixture had polymerized and hardened into a solid. The mold was then again placed in the oven at 100° C. and cured for 16 hours.

After the oven curing was complete, the double shear specimen was removed from the mold, small amounts of excess polyurethane was trimmed away from the pins and the samples were allowed to age at room temperature for another week before testing. The pins were 14 mm long with a diameter of 10 mm. The polyurethane samples bonded between the pins were 2 mm wide.

The double shear specimens were then submitted for dynamic testing on a Metravib DMA+450 testing machine. The temperature was varied during the testing from room temperature down to −80° C. and then up to 120° C. at a rate of 1.5° C./min at a frequency of 10 Hz at a constant force of 15.7N. The dynamic testing on the double shear specimens was successfully completed. What are the dimensions of the pins and the polyurethane sample size?

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A mold for preparing a viscoelastic material for dynamic analysis, the mold comprising:
mold sections that when closed in alignment define elements comprising:
a specimen cavity having an open end, the specimen cavity dimensioned to provide a sample of the viscoelastic material of a predetermined size;
a support member holder adjacent to the open end of the specimen cavity; and
a fill channel in fluid communication between the specimen cavity and a fill port, the fill port adapted for receiving a reactive mixture of the viscoelastic material to fill the specimen cavity, wherein the support member holder is adapted for securing a support member having a surface that seals the open end of the specimen cavity.

2. The mold of claim 1, further comprising a ridge in the support member holder, the ridge adapted for fitting into a notch in the support member to further secure the support member in the support member holder.

3. The mold of claim 2, wherein the ridge is machined into the support member holder.

4. The mold of claim 2, wherein the ridge is a removable bar secured in at least one of the mold sections.

5. The mold of claim 1, further comprising a closed channel within at least one of the mold sections, the closed channel having a fluid inlet at one end and a fluid outlet at an opposite end for circulating a thermal fluid therethrough.

6. The mold of claim 1, further comprising a heating element attached to at least one of the mold sections.

7. The mold of claim 1, further comprising a heating element embedded within at least one of the mold sections.

8. The mold of claim 1, wherein the fill channel is placed in fluid communication with the specimen cavity through a gate extending between the fill channel and the specimen cavity.

9. The mold of claim 1, wherein the fill port is adapted for connection to a reaction injection molding process.

10. The mold of claim 1, wherein the support member holder is adapted to secure a support member selected from a plate, a pin or combinations thereof.

11. The mold of claim 1, wherein the specimen cavity is dimensioned to provide the sample of the viscoelastic material as a shape selected from a cube, a cylinder, a cone or combinations thereof.

12. A mold for preparing a viscoelastic material for dynamic analysis, the mold comprising:
mold sections that when closed in alignment define elements comprising:
two cavities, each of the cavities having adjacent proximal open ends and opposing distal open ends, the cavities dimensioned to provide dual samples of the viscoelastic material of a predetermined size;
a center support member holder extending between the adjacent proximal open ends of the cavities;
a first support member holder and a second support member holder, each adjacent to each of the opposing distal open ends of the cavities; and
a fill channel in fluid communication between the cavities and a fill port, the fill port adapted for receiving a reactive mixture of the viscoelastic material to fill the cavities, wherein the center support member holder is adapted for securing a center support member having a center support surface that seals the proximal open ends of the specimen cavity and the first support member holder and second support member holder are each adapted for securing a first support member and second support member respectively, having a first and a second support surface respectively that seals the distal open ends of the specimen cavity.

13. The mold of claim 12, further comprising a ridge in the first, second and center support member holders, the ridge adapted for fitting into a notch in the support members to further secure the center, first and second support members in the support member holders.

14. The mold of claim 13, wherein the ridge is machined into the support member holders.

15. The mold of claim 13, wherein the ridge is a removable bar secured in one of the mold sections.

16. The mold element of claim 12, wherein the fill port is adapted for connection to an injection molding extruder.

17. A method for preparing a viscoelastic material for dynamic analysis, the method comprising:
preparing a bonding surface of a support member for bonding the viscoelastic material thereto;
securing the support member in a mold, wherein the prepared bonding surface of the support member borders an open end of a specimen cavity in the mold and wherein the specimen cavity is dimensioned to provide a sample of the viscoelastic material of a predetermined size;
filling the specimen cavity with a reactive mixture of the viscoelastic material;
curing the reactive mixture to form the viscoelastic material; and
removing the support member from the mold with the viscoelastic material bonded thereto.

18. The method of claim 17, wherein preparing the bonding surface comprises:
roughening the bonding surface; and
cleaning the bonding surface.

19. The method of claim 17, wherein preparing the bonding surface comprises:
coating the bonding surface with an adhesive.

20. The method of claim 17, wherein the viscoelastic material is selected from polyurethane, polyurea, polyamide or polyurethaneurea.
